(19) United States
(12) Patent Application Publication
(10) Pub. No.: US 2026/0194990 A1
(43) Pub. Date: Jul. 9, 2026

(54) JOYSTICK DEVICE AND ELECTRONIC EQUIPMENT

(71) Applicant: Chipsemi Semiconductor (NingBo) Co., Ltd., Ningbo (CN)

(72) Inventors: Kejia LIU, Ningbo (CN); Yaoguo ZHANG, Ningbo (CN); Yibin WU, Ningbo (CN); Bo NIE, Ningbo (CN); Yongfeng SANG, Ningbo (CN); Guanchun JIANG, Ningbo (CN)

(21) Appl. No.: 19/557,093

(22) Filed: Mar. 4, 2026

Related U.S. Application Data
(63) Continuation of application No. PCT/CN2025/137654, filed on Nov. 26, 2025.

(30) Foreign Application Priority Data
Dec. 17, 2024 (CN) 202411861719.4

(51) Int. Cl. G06F 3/0338; A63F 13/24

(52) U.S. Cl. CPC G06F 3/0338; A63F 13/24

(57) ABSTRACT

The present disclosure relates to the technical field of angle measurement, and discloses a joystick device and electronic equipment. The joystick device of the present disclosure includes: a joystick, a rocker arm structure, a circuit board, an upper cover, and a processor. A receiving cavity is formed between the upper cover and the circuit board, and the upper cover is provided with a limiting hole. The rocker arm structure is disposed inside the receiving cavity, one end of the joystick is connected to the rocker arm structure, and the other end of the joystick extends out of the upper cover through the limiting hole.

### CROSS REFERENCE TO RELATED APPLICATIONS

This application is a continuation of PCT Patent Application No. PCT/CN2025/137654, entitled “JOYSTICK DEVICE AND ELECTRONIC EQUIPMENT,” filed November 26, 2025, which claims priority to Chinese Patent Application No. 2024118617194, entitled “JOYSTICK DEVICE AND ELECTRONIC EQUIPMENT,” filed on December 17, 2024, each of which is incorporated by reference herein in its entirety.

### TECHNICAL FIELD

The present disclosure relates to the technical field of angle measurement, and particularly relates to a joystick device and an electronic equipment.

### BACKGROUND

Currently, joysticks have wide applications in fields such as medical devices, drone control handles, and game controllers. For example, position control of medical devices, orientation control on drone control handles, and position control on game controllers. At this stage, higher requirements have also been put forward for the accuracy of angle measurement of joystick rotation.

In the related art, the rotation angle of a joystick is mainly detected by sensors. Common sensors include Hall sensors, carbon film sensors, etc. Hall sensors have problems such as being susceptible to external magnetic interference and having a non-linear relationship between signal and distance. Carbon film sensors have problems such as contact wear and low detection accuracy. Therefore, the technical solution of achieving joystick angle measurement through sensor detection has low accuracy and cannot meet users' increasingly higher demands for the accuracy of joystick angle measurement.

### SUMMARY

In some embodiments, some embodiments of the present disclosure are intended to provide a joystick device and an electronic equipment, thereby improving the accuracy of angle measurement of the joystick device.

To solve the above technical problems, in embodiments of the present disclosure, a joystick device is provided. The joystick device includes: a joystick, a rocker arm structure, a processor, a circuit board, and an upper cover covering the circuit board; where the upper cover and the circuit board define a receiving cavity, the upper cover is provided with a limiting hole on a side away from the circuit board. The rocker arm structure is disposed inside the receiving cavity. The joystick has one end connected to the rocker arm structure, and an other end extending out of the upper cover through the limiting hole. The rocker arm structure has a plurality of rotating shafts, at least one of the plurality of rotating shafts is provided with a rotating portion on a side of the rocker arm structure facing the circuit board. The joystick device further includes metal sheets, and the metal sheets includes a respective metal sheet disposed on a surface of the rotating portion facing the circuit board. A first surface of the circuit board is provided with electrode plate assemblies corresponding to the metal sheets, and the first surface is a surface of the circuit board facing the rocker arm structure. The processor is connected to the circuit board. Each of the electrode plate assemblies includes a first electrode plate and second electrode plates. In response to a respective one of a plurality of rotating portions being rotated following the joystick, a relative area between a respective metal sheet and a respective second electrode plate of the second electrode plates in an electrode plate assembly of the electrode plate assemblies corresponding to the respective metal sheet changes. The relative area being an area of an orthographical projection of one plate on the other plate. The first electrode plate, the respective metal sheet, and the respective second electrode plate form a target capacitor. The processor is configured to obtain capacitance values of a plurality of target capacitors, and determine rotation directions and angles of the joystick according to the capacitance values.

In some embodiments of the present disclosure, an electronic equipment including the above-mentioned joystick device is also provided.

In some embodiments, each of the plurality of rotating portions includes an extension member and a slider; the extension member is provided in in a direction of the at least one rotating shaft perpendicular to the first surface of the circuit board, and the slider is provided with a recess on a side facing the at least one rotating shaft, with the extension member disposed in the groove.

In some embodiments, the surface of the rotating portion facing the circuit board is an arc surface.

In some embodiments, the rocker arm structure includes a lower rocker arm and an upper rocker arm covering the lower rocker arm, the upper rocker arm rotates following the joystick along a first axis, the lower rocker arm rotates following the joystick along a second axis, and the first axis is perpendicular to the second axis. The upper rocker arm is provided with two rotating shafts of the plurality of rotating shafts along the first axis direction, and the lower rocker arm is provided with two rotating shafts along the second axis direction. A first sliding opening is provided on a side of the upper rocker arm facing the upper cover, a second sliding opening is provided on a side of the lower rocker arm facing the upper cover. Positioning holes are provided on both side walls of the lower rocker arm perpendicular to the first surface, and positioning members in one-to-one correspondence with the positioning holes are provided at an end of the joystick connected to the rocker arm structure. The joystick passes through the first sliding opening and the second sliding opening in sequence, so that the positioning members are assembled in the positioning holes.

In some embodiments, each of the electrode plate assemblies includes a plurality of second electrode plates. In response to the rotating portion being rotated following the joystick, the relative area between a respective metal sheet and each second electrode plate changes. The first electrode plate, the respective metal sheets, and each second electrode plate each form a target capacitance. The processor is configured to obtain capacitance values of a plurality of target capacitors, and determine the rotation directions and angles of the joystick according to the plurality of capacitance values.

In some embodiments, each of electrode plate assemblies further includes a ground plate, and the ground plate is disposed between the first electrode plate and the second electrode plates.

In some embodiments, among the plurality of rotating shafts, the number of rotating shafts provided with the rotating portions is two, and the two rotating shafts have different rotation directions.

In some embodiments, each of the plurality of rotating shafts is provided with a rotating portion on a side of the rocker arm structure facing the circuit board.

In some embodiments, the joystick device further includes a button, and a dome sheet is provided on a side of the button away from the upper cover. A button area corresponding to the dome sheet is provided on the first surface of the circuit board.

The technical solutions provided by embodiments of the present disclosure have at least the following advantages:

By providing metal sheets and electrode plate assemblies in the joystick device in some embodiments, each of the electrode plate assemblies forms a target capacitor through coupling with the respective metal sheet. In response to the joystick being rotated, the joystick drives the respective rotating portion to rotate through the respective rotating shaft, causing the relative area between the respective metal sheet and the respective second electrode plates to change, and the capacitance value of the target capacitor formed by the respective metal sheet, the first electrode plate, and each second electrode plate changes. That is, at different rotation angles, the capacitance value of the target capacitor is different, so that rotation directions and angles of the joystick can be detected through the changes in capacitance values of the target capacitors. Compared with the sensor method of the related art, in these embodiments, angle measurement of the joystick device may be realized through capacitance detection, the rotation directions and angles of the joystick may be accurately determined through target capacitor changes, and the accuracy of angle measurement of the joystick device may be improved.

### BRIEF DESCRIPTION OF THE DRAWINGS

One or more embodiments are exemplified by corresponding figures in the drawings. These exemplary illustrations do not constitute limitations on the embodiments. Elements with the same reference numerals in the drawings represent similar elements. Unless otherwise stated, the drawings are not to scale.

FIG. 1 is a structural schematic diagram of a joystick device according to embodiments of the present disclosure;

FIG. 2 is a cross-sectional structural schematic diagram of a joystick device according to some embodiments of the present disclosure;

FIG. 3 is an exploded structural schematic diagram of a joystick device according to some embodiments of the present disclosure;

FIG. 4 is a structural schematic diagram of a circuit board according to embodiments of the present disclosure;

FIG. 5 is a structural schematic diagram of an electrode plate assembly according to some embodiments of the present disclosure;

FIG. 6 is a first partial enlarged schematic diagram of a rotating portion according to some embodiments of the present disclosure;

FIG. 7 is a second partial enlarged schematic diagram of a rotating portion according to some embodiments of the present disclosure;

FIG. 8 is a structural schematic diagram of a slider according to embodiments of the present disclosure;

FIG. 9 is a schematic diagram of a positional relationship between a metal sheet and an electrode plate assembly according to some embodiments of the present disclosure;

FIG. 10 is a line trend diagram of an electric field formed between a metal sheet and an electrode plate assembly according to some embodiments of the present disclosure;

FIG. 11 is a structural schematic diagram of a circuit board according to some embodiments of the present disclosure;

FIG. 12 is an exploded structural schematic diagram of a joystick device according to some embodiments of the present disclosure;

FIG. 13 is a partial structural schematic diagram of a joystick device according to some embodiments of the present disclosure; and

FIG. 14 is a structural schematic diagram of an electronic equipment according to embodiments of the present disclosure;

### DETAILED DESCRIPTION OF THE EMBODIMENTS

As can be seen from the background art, the joystick in the related art has low accuracy and cannot meet users' increasingly higher demands for joystick accuracy.

To solve the problem of low joystick accuracy in the related art, embodiments of the present disclosure relate to a joystick device, including: a joystick, a rocker arm structure, a processor, a circuit board, and an upper cover covering the circuit board. The upper cover and the circuit board define a receiving cavity, the upper cover is provided with a limiting hole on a side of the upper cover away from the circuit board. The rocker arm structure is disposed inside the receiving cavity, one end of the joystick is connected to the rocker arm structure, and the other end of the joystick extends out of the upper cover through the limiting hole. The rocker arm structure has a plurality of rotating shafts, at least one rotating shaft of the plurality of rotating shafts is provided with a rotating portion on a side of the rocker arm structure facing the circuit board. The joystick device further includes metal sheets, and the metal sheets includes a first metal sheet disposed on a surface of the rotating portion facing the circuit board. A first surface of the circuit board facing the rocker arm structure is provided with electrode plate assemblies corresponding to the metal sheets. The processor is connected to the circuit board. Each of the electrode plate assemblies includes a first electrode plate and second electrode plates. In response to the rotating portion being rotated following the joystick, the relative area between the metal sheet and the second electrode plates changes. The first electrode plate, the metal sheet, and the second electrode plates form a plurality of target capacitors. The processor is configured to obtain capacitance values of the plurality of target capacitors, and determine rotation directions and angles of the joystick according to the capacitance values.

By providing metal sheets and the electrode plate assemblies in the joystick device in embodiments, each of the electrode plate assemblies forms a capacitor through coupling with a respective metal sheet of the metal sheets. In response to the joystick being rotated, the joystick drives a respective rotating portion to rotate through a corresponding rotating shaft of the plurality of rotating shafts, causing the relative area between the respective metal sheet and the respective second electrode plates to change, and the capacitance value of the target capacitor formed by the respective metal sheet, the first electrode plate, and the respective second electrode plate changes. That is, at different rotation angles, the capacitance value of the target capacitor is different, so that the rotation angles of the joystick can be detected through the change in capacitance values of the target capacitors. Compared with the sensor method of the related art, this embodiment realizes angle measurement of the joystick device through capacitance detection, is capable of accurately determining the rotation direction and angle of the joystick through target capacitor changes, and improves the accuracy of angle measurement of the joystick device.

To make the objectives, technical solutions, and advantages of some embodiments of the present disclosure clearer, various embodiments of the present disclosure would be described in detail below with reference to the accompanying drawings. However, those of ordinary skill in the art may understand that in various embodiments of the present disclosure, many technical details are provided to enable readers to better understand the present disclosure. However, even without these technical details and various changes and modifications based on the following embodiments, the technical solutions claimed by the present disclosure may still be realized. The division of the following embodiments is for convenience of description and should not constitute any limitation on the specific implementation of the present disclosure. The various embodiments may be combined and referenced with each other without contradiction.

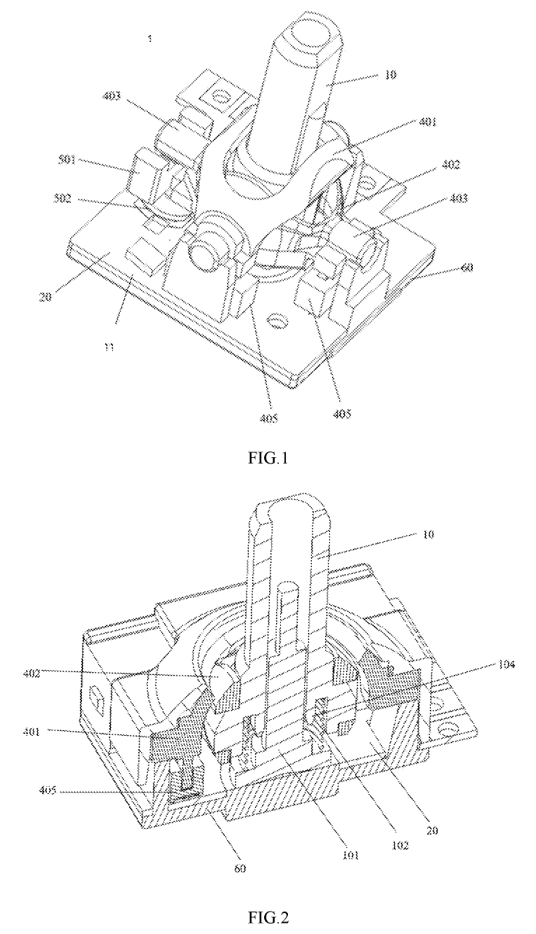

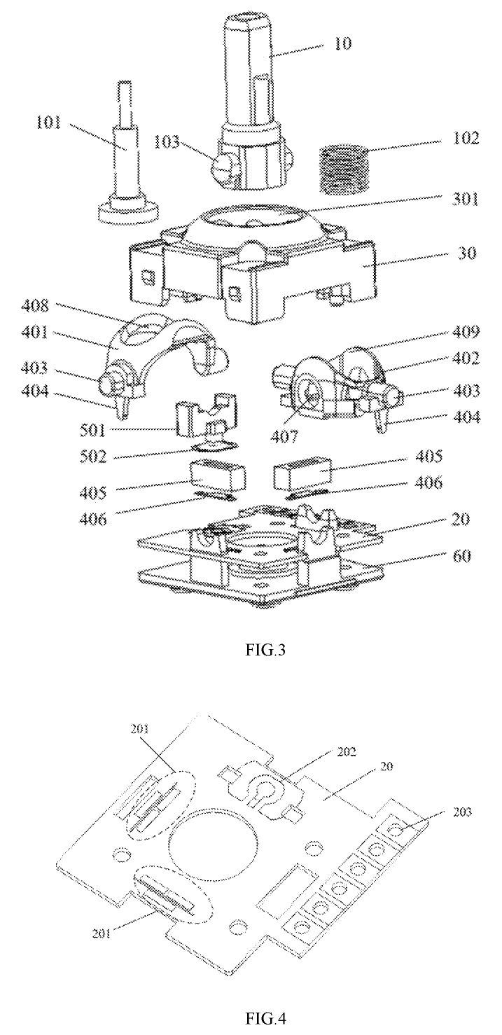

Embodiments of the present disclosure relate to a joystick device . As shown in FIG. 1, which is a structural schematic diagram of the joystick device according to some embodiments of the present disclosure, as shown in FIG. 2, which is a cross-sectional structural schematic diagram of a joystick device according to some embodiments of the present disclosure, and as shown in FIG. 3, which is an exploded structural schematic diagram of a joystick device according to some embodiments of the present disclosure, the joystick device 1 includes: a joystick 10, a rocker arm structure (not shown in the figures), a processor 11, a circuit board 20, and an upper cover 30 covering the circuit board 20.

Specifically, a receiving cavity is formed between the upper cover 30 and the circuit board 20, and a limiting hole 301 is provided on a side of the upper cover 30 away from the circuit board 20. The rocker arm structure (including an upper rocker arm 401 and a lower rocker arm 402) is disposed inside the receiving cavity, one end of the joystick 10 is connected to the rocker arm structure, and the other end of the joystick 10 extends out of the upper cover 30 through the limiting hole 301. The rocker arm structure has a plurality of rotating shafts 403, at least one rotating shaft 403 is provided with a rotating portion (including an extension member 404 and a slider 405) on a side of the rocker arm structure facing the circuit board 20, and metal sheets 406, each of which is disposed on a surface of a respective rotating portion of the rotating portions faing the circuit board 20.

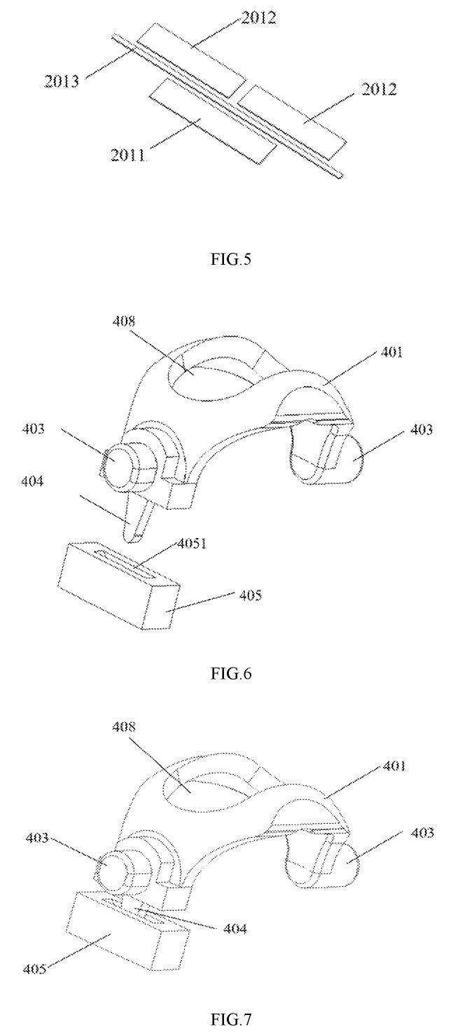

As shown in FIG. 4, which is a structural schematic diagram of a circuit board according to some embodiments of the present disclosure, a first surface of the circuit board 20 is provided with electrode plate assemblies 201 disposed opposite to metal sheets 406 respectively. As shown in FIG. 5, which is a structural schematic diagram of a respective electrode plate assembly according to some embodiments of the present disclosure, the first surface is a surface of the circuit board 20 facing the rocker arm structure. The processor 11 is connected to the circuit board 20, and each of the electrode plate assemblies 201 includes a first electrode plate 2011 and a plurality of second electrode plates 2012. In response to the respective rotating portion being rotated following the joystick 10, the relative area between the respective metal sheet 406 and the second electrode plates 2012 of the electrode plate assembly corresponding to the respective metal sheet 406 changes, and the first electrode plate 2011, the respective metal sheet 406, and the second electrode plates 2012 form a target capacitor. A plurality of pins 203 are also provided on the circuit board 20, to transmit the signals of the target capacitor received by the circuit board 20 to the processor 11. The processor 11 is configured to obtain the capacitance values of the target capacitors from the circuit board 20, and determine the rotation directions and angles of the joystick 10 according to the capacitance values. Through detection and data processing of the capacitance values of the target capacitors in the embodiments, the rotation states of the joystick 10 may be fed back, and the processor 11 calculates the rotation directions and angles of the joystick 10 according to an algorithm.

Specifically, each of the electrode plate assemblies 201 further includes a ground plate 2013, and the ground plate 2013 is disposed between the first electrode plate 2011 and the plurality of second electrode plates 2012. By providing the ground plate 2013 between the first electrode plate 2011 and the plurality of second electrode plate 2012 in the embodiments, the first electrode plate 2011 and the second electrode plates 2012 can be isolated to prevent electrical signals between the first electrode plate 2011 and the second electrode plates 2012 from mutual interference, thereby improving detection accuracy.

Specifically, the first electrode plate 2011 is closer to the edge of the circuit board 20, the ground plate 2013 is disposed on a side of the first electrode plate 2011 away from the edge of the circuit board 20, and the plurality of second electrode plates 2012 are disposed on a side of the ground plate 2013 away from the first electrode plate 2011, where the distance between the ground plate 2013 and one of the second electrode plates 2012 is the same as the distance between the ground plate 2013 and another of the second electrode plates 2012.

Continuing to refer to FIGS. 1, 2, and FIG. 3, the rocker arm structure of some embodiments includes a lower rocker arm 402 and an upper rocker arm 401 covering the lower rocker arm 402. The upper rocker arm 401 rotates following the joystick 10 along a first axis, the lower rocker arm 402 rotates following the joystick 10 along a second axis, and the first axis and the second axis are perpendicular to each other. The upper rocker arm 401 is provided with two rotating shafts 403 along the first axis direction, and these two rotating shafts 403 are located on both sides of the upper rocker arm 401 respectively. The lower rocker arm 402 is provided with two rotating shafts 403 along the second axis direction, and these two rotating shafts 403 are located on both sides of the lower rocker arm 402 respectively. A first sliding opening 408 is provided on a side of the upper rocker arm 401 facing the upper cover 30, and a second sliding opening 409 is provided on a side of the lower rocker arm 402 facing the upper cover 30, with the first sliding opening 408 and the second sliding opening 409 facing the same direction. The lower rocker arm 402 has two side walls that are symmetrical along the second axis direction and perpendicular to the first surface, positioning holes 407 are provided on both side walls of the lower rocker arm 402, and positioning members 103 matching the positioning holes 407 one-to-one are provided at an end of the joystick 10 connected to the rocker arm structure, specifically two positioning members 103. An end of the joystick 10 connected to the rocker arm structure passes through the first sliding opening 408 and the second sliding opening 409 in sequence, so that the positioning members 103 are assembled in the positioning holes 407.

Specifically, during the rotation of the joystick 10, the joystick 10 may rotate in the first sliding opening 408 and drive the lower rocker arm 402 to rotate following the joystick 10 along the second axis, while the upper rocker arm 401 does not rotate. The joystick 10 may also rotate in the second sliding opening 409 and drive the upper rocker arm 401 to rotate following the joystick 10 along the first axis, while the lower rocker arm 402 does not rotate. Through this method, the movement of the joystick 10 is realized. Electrode plate assemblies 201 corresponding to the rotating portions provided on the rotating shafts 403 of the upper rocker arm 401 are used to detect the rotation angles of the joystick 10 on the first axis, and the electrode plate assemblies 201 corresponding to the rotating portions provided on the rotating shafts 403 of the lower rocker arm 402 are used to detect the rotation angles of the joystick 10 on the second axis, thereby realizing the detection of the rotation angles of the joystick 10 in various directions, and then determining the rotation directions of the joystick 10 and the rotation angles of the joystick 10 in the rotation directions according to the rotation angles in various directions.

Specifically, a base 60 is also provided on a side of the circuit board 20 away from the joystick 10, that is, the circuit board 20 is disposed on the base 60. The base 60 provides support and protection for the circuit board 20, improving the operational stability of the circuit board 20.

Specifically, the joystick 10 in the embodiments defines a cavity, and a reset rod 101 is provided in the cavity. The bottom of the reset rod 101 is connected to the circuit board 20, and a spring 102 is sleeved on the reset rod 101. The bottom of the spring 102 is connected to the bottom of the reset rod 101, and the bottom of the spring 102 abuts against the bottom of the reset rod 101. A limiting member 104 is provided in the cavity of the joystick 10 to form a limiting groove, and the top of the spring 102 is disposed inside the limiting groove, realizing an elastic connection between the joystick 10 and the reset rod 101 through the spring 102. By providing the reset rod 101 in the embodiments, the reset of the joystick 10 can be realized. The reset rod 101 is also sleeved with a spring 102. By sleeving the spring 102, the reset speed of the joystick 10 is increased, and reset delay is reduced as much as possible.

Specifically, as shown in FIG. 4, the joystick device of some embodiments further includes a button 501, and a dome sheet 502 is provided on a side of the button 501 away from the upper cover 30. A button area 202 corresponding to the dome sheet 502 is provided on the first surface of the circuit board 20.

Among them, the button 501 has a "recessed" structure, that is, a recess is provided on a side of the button 501 away from the circuit board 20, and one of the rotating shafts 403 of the rocker arm structure is disposed in the recess. When the joystick 10 is pressed, the rocker arm structure presses the button 501 through this rotating shaft 403. After the button 501 is pressed, the button 501 presses the dome sheet 502. The dome sheet 502 acts as a switch, triggering the button area 202 in the circuit board 20 through the dome sheet 502, thereby triggering the corresponding function. In practical applications, when a user plays a game through a game controller having a joystick 10, some scenarios require the button 501 to confirm, for example, a user needs to select a character image through the button 501. The user first selects a character image from a row of character images by moving the joystick 10 left and right, and then presses the joystick 10 downward, thereby driving the button 501 to be pressed. The button 501 then presses the dome sheet 502, and after being pressed, the corresponding button area 202 in the circuit board 20 is triggered, and the user has selected this character image.

Continuing to refer to FIGS. 4 and 5, each of the electrode plate assemblies 201 of some embodiments includes a plurality of second electrode plates 2012. FIGS. 4 and 5 illustrate the case where the number of second electrode plates 2012 is two. To obtain better detection accuracy, the number of second electrode plates 2012 may also be set to three, four, etc.

Specifically, in response to the respective rotating portion being rotated following the joystick 10, the relative area between the respective metal sheet 406 and each second electrode plate 2012 changes. The first electrode plate 2011, the respective metal sheet 406, and each second electrode plate 2012 form a target capacitor. The processor 11 is configured to obtain the capacitance values of the plurality of target capacitors, and determine the rotation directions and angles of the joystick 10 according to the plurality of capacitance values. The first electrode plate 2011 of some embodiments forms a target capacitor with each second electrode plate 2012 through the respective metal sheet 406. By utilizing the relationship among the capacitance values of the plurality of target capacitors, algorithms can cleverly eliminate the influence of factors such as gap changes between the electrode plate assemblies 201 and the metal sheets 406, and changes in dielectric constant on the rotation angle, achieving better detection effects. The more second electrode plates 2012 there are, the higher the detection accuracy.

It should be noted that the relative area between the first electrode plate 2011 and the respective metal sheet 406 in embodiments is fixed and unchanged. Even when the rotating portion rotates following the joystick 10, the relative area between the first electrode plate 2011 and the respective metal sheet 406 does not change, so that the change in target capacitor is only related to the relative area between the metal sheet 406 and the respective second electrode plate 2012, further improving detection accuracy. The first electrode plate 2011 of some embodiments is a transmitting electrode plate, and the respective second electrode plate 2012 is a receiving electrode plate. In other embodiments, the first electrode plate 2011 may be a receiving electrode plate, and the respective second electrode plate 2012 may be a transmitting electrode plate.

As shown in FIG. 6, which is a first partial enlarged schematic diagram of a respective rotating portion according to some embodiments of the present disclosure, and as shown in FIG. 7, which is a second partial enlarged schematic diagram of a respective rotating portion according to some embodiments of the present disclosure, the rotating portion of some embodiments includes an extension member 404 and a slider 405. The rotating shaft 403 is provided with the extension member 404 in a direction perpendicular to the circuit board 20, and a groove 4051 is provided on a side of the slider 405 facing the rotating shaft 403, with the extension member 404 disposed in the groove 4051. The figure illustrates the rotating portion on the upper rocker arm 401 as an example. The structure of a rotating portion on the lower rocker arm 402 is similar and would not be repeated here to avoid redundancy.

Specifically, the extension member 404 has a "V" structure, and the groove in the slider 405 also has a "V" shape, but the angle of the "V" structure of the groove is greater than the angle of the "V" structure of the extension member 404, so that the extension member 404 has a certain amount of movement space in the groove, ensuring that the slider 405 moves in a straight line. Taking the rotating portion located on the upper rocker arm 401 as an example, when the joystick 10 drives the rotating portion to rotate, the extension member 404 rotates along the first axis. Since the extension member 404 are located in the groove of the slider 405, the slider 405 follows the extension member 404 to move linearly. The distance between the metal sheet 406 at the bottom of the slider 405 and the electrode plate assembly 201 remains unchanged, and only the relative area between the metal sheet 406 and the second electrode plate 2012 changes, thereby reducing the influence of distance on the target capacitors and improving detection accuracy. The rotation principle of the rotating portion located on the lower rocker arm 402 is similar and would not be repeated in embodiments to avoid redundancy.

Specifically, when the joystick 10 swings, it drives the slider 405 to move linearly, further driving the metal sheet 406 to move linearly. Specifically, during the movement of the metal sheet 406, the relative area between the metal sheet 406 and the first electrode plate 2011 remains unchanged, and the relative area between the respective metal sheet 406 and each of the two second electrode plates 2012 changes, and the area have a linear relationship with displacement. The relative area between one second electrode plate 2012 and the metal sheet 406 is recorded as S1, and another relative area between another second electrode plate 2012 and the metal sheet 406 is recorded as S2. The target capacitor formed by the first electrode plate 2011 and one second electrode plate 2012 is recorded as C1, and the target capacitor formed by the first electrode plate 2011 and another second electrode plate 2012 is recorded as C2. According to the circuit structure and the driving and detection principles of the chip, C1/C2=S1/S2 may be obtained, or (C1-C2)/(C1+C2) may be obtained through differential calculation. Thus, based on the obtained target capacitances C1 and C2, the relationship between S1 and S2 may be obtained, thereby obtaining the rotation directions and angles of the joystick 10. Through this method, not only can the influence of uncertainty in the distance between the metal sheet 406 and the electrode plate assembly 201 and the uncertainty of the dielectric constant be eliminated, but also the detection accuracy of the position of the joystick 10 can be improved.

As shown in FIG. 8, which is a structural schematic diagram of a respective slider according to embodiments of the present disclosure, the metal sheet 406 located at the bottom of the slider 405 have a "convex" structure. As shown in FIG. 9, which is a structural schematic diagram between a metal sheet and an electrode plate assembly according to embodiments of the present disclosure. The shaded regions in FIG. 9 illustrate the relative area, which refers to the directly opposing and overlapping area of the capacitor plates in the vertical direction, understood as the effective area.In the figure, the "convex" structure of the metal sheet 406 has a wider first area and a narrower second area in the direction of movement of the slider 405. The wider first area is used to cover the first electrode plate 2011, so that the relative area between the first electrode plate 2011 and the metal sheet 406 remains unchanged during the rotation of the joystick 10. The narrower second area in the metal sheet 406 is disposed opposite to the second electrode plates 2012, so that during the rotation of the joystick 10, the relative area between the metal sheet 406 and each second electrode plate 2012 changes, thereby determining the rotation directions and angles of the joystick 10 according to the change in capacitance values of the target capacitances.

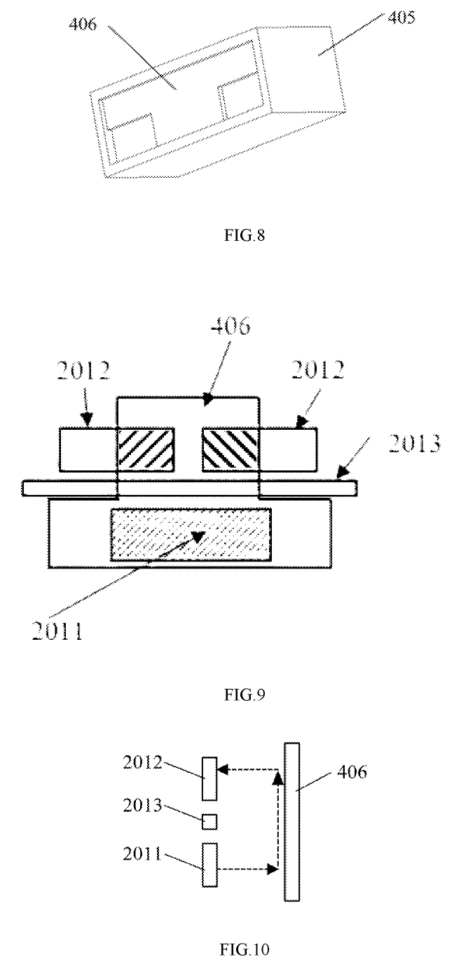

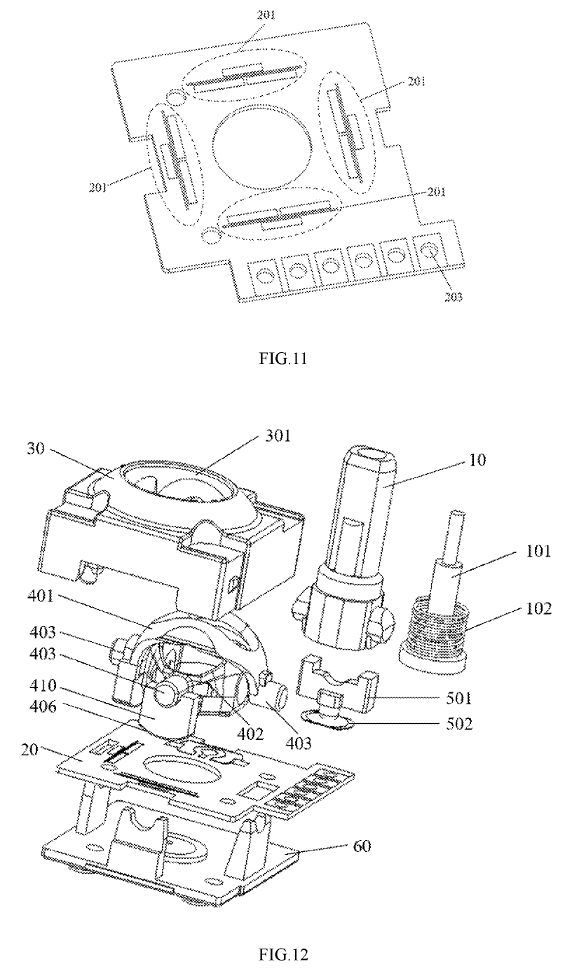

As shown in FIG. 10, which is an electric field line trend diagram between a respective metal sheet and a respective electrode plate assembly according to embodiments of the present disclosure, taking the first electrode plate 2011 being a transmitting electrode plate and the second electrode plates 2012 being receiving electrode plates as an example, the metal sheet 406 is in a floating state, and the electrical signal reaches the metal sheet 406 from the first electrode plate 2011 and then reaches the second electrode plates 2012, so that under the action of the metal sheet 406, a target capacitor is formed between the first electrode plate 2011, the metal sheet 406, and the respective second electrode plate 2012.

In some embodiments, among the plurality of rotating shafts 403, the number of rotating shafts 403 provided with rotating portions is two, and the two rotating shafts 403 have different rotation directions. Continuing to refer to FIGS. 1, 2, and FIG. 3, the joystick device has four rotating shafts 403, where two rotating shafts 403 are provided by the upper rocker arm 401, and the other two rotating shafts 403 are provided by the lower rocker arm 402. The four rotating shafts 403 are respectively disposed around the rocker arm structure. One rotating shaft 403 of the upper rocker arm 401 in some embodiments is provided with one rotating portion, and one rotating shaft 403 of the lower rocker arm 402 is provided with one rotating portion. These two rotating portions are disposed on two adjacent rotating shafts 403. Correspondingly, two corresponding electrode plate assemblies 201 are provided on the circuit board 20. As shown in FIG. 4, which is a structural schematic diagram of the circuit board 20 of some embodiments, two electrode plate assemblies 201 are provided on the first surface of the circuit board 20, and the two electrode plate assemblies 201 are disposed on two adjacent sides of the first surface. That is, in some embodiments, one rotating portion is provided on one rotating shaft 403 of the upper rocker arm 401 to detect the rotation angle of the joystick 10 on the first axis, and another rotating portion is provided on one rotating shaft 403 of the lower rocker arm 402 to detect the rotation angle of the joystick 10 on the second axis. Thus, according to the rotation angles of the joystick 10 in various directions, not only the rotation directions of the joystick 10 may be determined, but also the rotation angles of the joystick 10 in the rotation direction may be determined.

Since only two rotating portions are provided in some embodiments, a button 501 may also be provided at the respective rotating shaft 403 where no rotating portions are provided. As shown in FIGS. 1, 2, and FIG. 3, one rotating shaft 403 of the lower rocker arm 402 is provided with a rotating portion, and the other rotating shaft 403 is disposed in the recess of the button 501. In other embodiments, the button 501 may be provided at one rotating shaft 403 of the upper rocker arm 401, that is, one rotating shaft 403 of the upper rocker arm 401 is provided with a rotating portion, and the other rotating shaft 403 is disposed in the recess of the button 501, thereby achieving the same function.

In some embodiments, each of the plurality of rotating shafts 403 is provided with a rotating portion on a side of the rocker arm structure facing the circuit board 20. As shown in FIGS. 1, 2, and FIG. 3, the joystick device has four rotating shafts 403, where two rotating shafts 403 are provided in the upper rocker arm 401, and the other two rotating shafts 403 are provided in the lower rocker arm 402. The four rotating shafts 403 are respectively disposed around the rocker arm structure. Each rotating shaft 403 in some embodiments is provided with a rotating portion. Correspondingly, four corresponding electrode plate assemblies 201 are provided on the circuit board 20. As shown in FIG. 11, which is a structural schematic diagram of a circuit board according to some embodiments of the present disclosure, four electrode plate assemblies 201 are provided on the first surface of the circuit board 20, and the positions of the four electrode plate assemblies 201 correspond to the positions of the four metal sheets 406, respectively. That is, in some embodiments, two rotating shafts 403 of the upper rocker arm 401 are provided with rotating portions to detect the rotation angles of the joystick 10 on the first axis, and two rotating shafts 403 of the lower rocker arm 402 are provided with rotating portions to detect the rotation angles of the joystick 10 on the second axis. Thus, according to the rotation angles of the joystick 10 in various directions, not only the rotation directions of the joystick 10 can be determined, but also the rotation angles of the joystick 10 in the rotation directions can be determined. At the same time, since four target capacitors are formed in some embodiments, the accuracy of angle measurement of the joystick 10 can be further improved.

By providing the metal sheets 406 and the electrode plate assemblies 201 in the joystick device in some embodiments, each of the electrode plate assemblies 201 forms a target capacitor through coupling with a respective metal sheet 406 of the metal sheets. In response to the joystick 10 being rotated, the joystick 10 drives the rotating portions to rotate through the rotating shafts 403, causing the relative area between the respective metal sheet 406 and the second electrode plate 2012 to change, and the capacitance value of the target capacitor formed by the respective metal sheet 406 and each of the electrode plate assemblies 201 changes. That is, at different rotation angles, the capacitance values are different, so that the rotation directions and angles of the joystick 10 may be detected through the changes in capacitance values of the target capacitors. Compared with the sensor method of the related art, in some embodiments, the rotation directions and angles of the joystick 10 are obtained through capacitance detection, which can accurately determine the rotation directions and angle of the joystick 10 through the changes in capacitance values of the target capacitors, and improves the accuracy of angle measurement of the joystick device. At the same time, no additional sensor needs to be provided in some embodiments, saving the volume of the joystick device and being more conducive to the miniaturization design of the joystick device.

Another embodiment of the present disclosure relates to a joystick device. As shown in FIG. 12, which is an exploded structural schematic diagram of a joystick device according to some embodiments of the present disclosure, and as shown in FIG. 13, which is a partial structural schematic diagram of a joystick device according to some embodiments of the present disclosure, the joystick device in some embodiments includes: a joystick 10, a rocker arm structure (not labeled in the figure), a processor 11, a circuit board 20, and an upper cover 30 covering the circuit board 20.

Specifically, a receiving cavity is formed between the upper cover 30 and the circuit board 20, and a limiting hole 301 is provided on a side of the upper cover 30 away from the circuit board 20. The rocker arm structure (including an upper rocker arm 401 and a lower rocker arm 402) is disposed inside the receiving cavity, one end of the joystick 10 is connected to the rocker arm structure, and the other end of the joystick 10 extends out of the upper cover 30 through the limiting hole 301. The rocker arm structure has a plurality of rotating shafts 403, at least one rotating shaft 403 is provided with a rotating portion 410 on a side of the rocker arm structure facing the circuit board 20, and a metal sheet 406 are disposed on a surface of the rotating portion 410 facing the circuit board 20. Referring to FIGS. 4 and 11, a first surface of the circuit board 20 facing the rocker arm structure is provided with electrode plate assemblies 201 disposed opposite to the metal sheet 406. Each of the electrode plate assemblies 201 includes a first electrode plate 2011 and second electrode plates 2012. In response to the rotating portion 410 being rotated following the joystick 10, the relative area between the metal sheet 406 and each of the second electrode plates 2012 changes.

The difference between the joystick device of these embodiments and the joystick device of the previous embodiment is that: each of the rotating portions 410 of the previous embodiment includes an extension member 404 and a slider 405, while each of the rotating portions 410 of these embodiments is of an integral structure. Other structures are roughly the same, and would not be repeated here to avoid redundancy.

Specifically, in these embodiments, the surface of the rotating portion 410 facing the circuit board 20 is an arc surface. In practical applications, taking the rotating portion 410 located on the upper rocker arm 401 as an example, when the joystick 10 drives the rotating portion 410 to rotate, the rotating portion 410 rotate along the first axis. Since the bottom surface of the rotating portion 410 has an arc structure, when the rotating portion 410 rotates, the equivalent distance between the metal sheet 406 on the bottom surface of the rotating portion 410 and the electrode plate assembly 201 hardly changes, and only the relative area between the metal sheet 406 and each of the second electrode plates 2012 changes, thereby reducing the influence of distance on the target capacitance and improving detection accuracy. The rotation principle of the rotating portions 410 located on the lower rocker arm 402 is similar and would not be repeated in embodiments to avoid redundancy.

In these embodiments, in response to the rotating portion 410 being rotated following the joystick 10, regardless of how the rotation angle of the joystick 10 changes, the equivalent distance between the metal sheet 406 and the electrode plate assembly 201 hardly changes, so that the change in capacitance value of the target capacitor is only related to the relative area of the metal sheet 406 and the electrode plate assembly 201, improving the detection accuracy of the joystick 10.

Among them, the overlapping area between the metal sheet 406 and the first electrode plate 2011 remains unchanged, and the relative area between the metal sheet 406 and each of the two second electrode plates 2012 changes, and the area has a linear relationship with the displacement of the metal sheet 406. The relative area between one second electrode plate 2012 and the metal sheet 406 is recorded as S1, and the relative area between another second electrode plate 2012 and the metal sheet 406 is recorded as S2. The target capacitance formed by the first electrode plate 2011 and one second electrode plate 2012 is recorded as C1, and the target capacitance formed by the first electrode plate 2011 and another second electrode plate 2012 is recorded as C2. According to the circuit structure and the driving and detection principles of the chip, C1/C2=S1/S2 may be obtained, or (C1-C2)/(C1+C2) may be obtained through differential calculation. Thus, based on the obtained target capacitances C1 and C2, the relationship between S1 and S2 may be obtained, and then the rotation directions and angles of the joystick 10 may be calculated. Through this method, not only can the influence of uncertainty in the distance between the metal sheets 406 and the electrode plate assemblies 201 and the uncertainty of the dielectric constant be eliminated, but also the accuracy of angle measurement of the joystick 10 can be further improved.

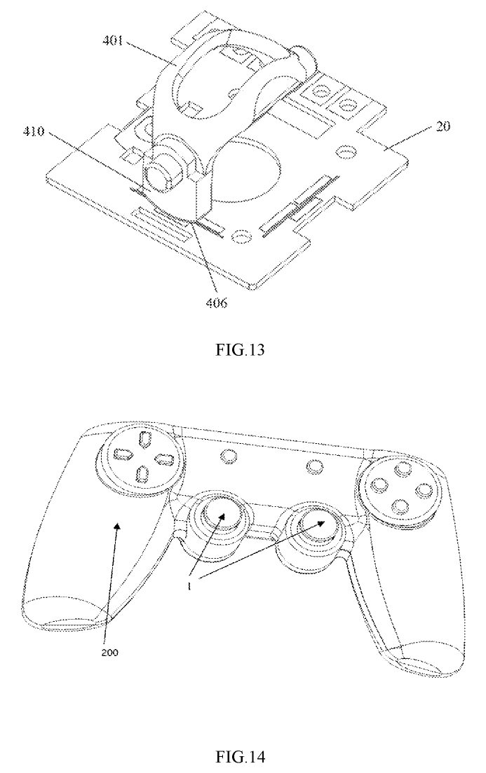

Another aspect of some embodiments of the present disclosure also provides an electronic equipment 200, as shown in FIG. 14, including: the above-mentioned joystick device.

In some embodiments, the electronic equipment 200 may be a game controller, keyboard, medical device, unmanned aerial vehicle, or other devices.

Since the electronic equipment 200 provided in some embodiments of the present invention includes the joystick device of the above embodiments, it also has the technical effects provided by the foregoing embodiments, which would not be repeated here.

The division of the various components above is only for clear description. During implementation, they can be combined into one component or some components can be split and decomposed into multiple components. As long as they include the same logical relationships, they are all within the protection scope of some embodiments.

Those of ordinary skill in the art may understand that the above embodiments are specific embodiments for implementing the present disclosure, and in practical applications, various changes can be made in form and details without departing from the spirit and scope of the present disclosure.

What is claimed is:

1. A joystick device, comprising:
a joystick;
a rocker arm structure;
a circuit board;
a processor coupled to the circuit board; and
an upper cover over the circuit board;
wherein the upper cover and the circuit board define a receiving cavity, the upper cover is provided with a limiting hole on a side away from the circuit board, and the rocker arm structure is disposed inside the receiving cavity;
the joystick has one end connected to the rocker arm structure and another end extending out of the upper cover through the limiting hole;
the rocker arm structure has a plurality of rotating shafts, at least one of the plurality of rotating shafts is provided with a rotating portion on a side of the rocker arm structure facing the circuit board;
the joystick device further comprises metal sheets, and the metal sheets include a first metal sheet disposed on a side of the rotating portion facing the circuit board;
the joystick device further comprises electrode plate assemblies, each of the electrode plate assemblies is disposed on a side of the circuit board facing the rocker arm structure and corresponds to a respective metal sheet of the metal sheets;
each of the electrode plate assemblies includes a first electrode plate and second electrode plates;
in response to the rotating portion being rotated following the joystick, a relative area between the first metal sheet and a respective second electrode plate of the second electrode plates in an electrode plate assembly of the electrode plate assemblies corresponding to the first metal sheet changes, and a relative area between the first electrode plate and the first metal sheet remains unchanged;
each of the electrode plate assemblies further comprises a ground plate, and the ground plate is disposed between the first electrode plate and the second electrode plates;
the first electrode plate, the metal sheets, and the respective second electrode plate form target capacitor;
the processor is configured to obtain the capacitance values of target capacitors, and determine rotation directions and angles of the joystick based at least one the capacitance values.

2. The joystick device according to claim 1, wherein the rotating portion comprises an extension member and a slider;
the extension member is provided in a direction of the at least one rotating shaft perpendicular to the first surface of the circuit board, and the slider is provided with a recess on a side facing the at least one rotating shaft, with the extension member disposed in the groove.

3. The joystick device according to claim 1, wherein the surface of the rotating portion facing the circuit board is an arc surface.

4. The joystick device according to claim 1, wherein the rocker arm structure comprises a lower rocker arm and an upper rocker arm covering the lower rocker arm, the upper rocker arm rotates following the joystick along a first axis, the lower rocker arm rotates following the joystick along a second axis, and the first axis is perpendicular to the second axis;
the upper rocker arm is provided with two rotating shafts of the plurality of rotating shafts along the first axis direction, and the lower rocker arm is provided with two rotating shafts along the second axis direction;
a first sliding opening is provided on a side of the upper rocker arm facing the upper cover, a second sliding opening is provided on a side of the lower rocker arm facing the upper cover, positioning holes are provided on both side walls of the lower rocker arm perpendicular to the first surface, and positioning members in one-to-one correspondence with the positioning holes provided at an end of the joystick connected to the rocker arm structure;
the joystick passes through the first sliding opening and the second sliding opening in sequence, so that the positioning members are assembled in the positioning holes.

5. The joystick device according to claim 1, wherein each of the electrode plate assemblies comprises a plurality of second electrode plates; in response to the rotating portion being rotated following the joystick, the relative area between the first metal sheet and each of the plurality of second electrode plates changes;
the first electrode plate, the respective metal sheet, and each second electrode plate form a target capacitor; the processor is configured to obtain capacitance values of the plurality of target capacitors, and determine the rotation directions and angles of the joystick according to the plurality of capacitance values.

6. The joystick device according to claim 1, wherein the number of the at least one of the plurality of rotating shafts is two, and the two rotating shafts have different rotation directions.

7. The joystick device according to claim 1, wherein each of the plurality of rotating shafts is provided with one rotating portion on a side of the rocker arm structure facing the circuit board.

8. The joystick device according to claim 1, wherein the joystick device further comprises a button, and a dome sheet disposed on a side of the button away from the upper cover; and
the first surface of the circuit board has a button area corresponding to the dome sheet.

9. An electronic equipment, comprising the joystick device according to claim 1.
